(19) United States
(12) Patent Application Publication
(10) Pub. No.: US 2026/0328194 A1
(43) Pub. Date: Oct. 22, 2026

(54) Wind Turbine Blade Monitoring

(71) Applicant: Insight Analytics Solutions Holding Limited, Middlesex (GB)

(72) Inventors: Jesse Graeter; Tugan Eritenel, Nottingham (GB)

(21) Appl. No.: 19/137,587

(22) PCT Filed: Dec. 15, 2023
(86) PCT No.: PCT/GB2023/053267

§ 371 Date: Jun. 10, 2025

(30) Foreign Application Priority Data
Dec. 15, 2022 (GB) 2218937.7

(51) Int. Cl. F03D 17/00; F03D 1/06

(52) U.S. Cl. CPC F03D 17/028; F03D 1/066; F03D 17/022; F05B 2270/821

(57) ABSTRACT

The invention relates to monitoring attachment integrity of a wind turbine blade by measuring displacement between the blade root and pitch bearing. Example embodiments include a method of monitoring attachment integrity of a wind turbine blade having a blade root (301) attached to a pitch bearing (303) of a wind turbine, the method comprising measuring during operation of the wind turbine a displacement of the blade root (301) relative to the pitch bearing (303) in a direction parallel to a longitudinal axis (310) of the blade. The displacement may be recorded over time and an amplitude determined. An alert may be triggered if the displacement amplitude exceeds a predetermined displacement threshold.

### FIELD OF THE INVENTION

The invention relates to monitoring attachment integrity of a wind turbine blade by measuring displacement of the blade root relative to a pitch bearing.

### BACKGROUND

Wind turbines are subjected to intermittent and varying loading during use, which leads to wear and damage of various components such as bearings and blades. It is important to monitor such wear and damage so that repair and replacement of worn and damaged components can be carried out before failure. Monitoring of wind turbine blades is particularly important because structural failure can be catastrophic.

### SUMMARY OF THE INVENTION

In accordance with a first aspect of the invention there is provided a method of monitoring attachment integrity of a wind turbine blade having a blade root attached to a pitch bearing of a wind turbine, the method comprising measuring during operation of the wind turbine a displacement of the blade root relative to the pitch bearing in a direction parallel to a longitudinal axis of the blade.

The method may comprise recording the measured displacement over time and determining a displacement amplitude. An alert may be triggered if the displacement amplitude exceeds a predetermined displacement amplitude threshold.

Where the displacement is a first displacement at a first location around the pitch bearing, the method may comprise measuring a second displacement between the blade root and the pitch bearing in the direction parallel to the longitudinal axis of the blade at a second location around the pitch bearing. The method may comprise recording the measured first and second displacements over time and determining a phase difference between the first and second displacements. The method may comprise triggering an alert if the phase difference changes by more than a predetermined phase threshold.

The alert may be a signal transmitted from the wind turbine to a remote computer.

The alert may be a signal transmitted to a controller of the wind turbine, the controller causing the wind turbine to cease or derate operation on receiving the alert signal.

The displacement may be measured by a displacement sensor comprising a first part mounted to the blade root and a second part mounted to the pitch bearing. The displacement sensor may be a non-contact displacement sensor such as an inductive displacement sensor or an optical displacement sensor. The displacement sensor may alternatively be a mechanical sensor.

One of the first and second parts may comprise a non-contact inductive displacement sensor and the other of the first and second parts a target plate.

In accordance with a second aspect of the invention there is provided a system for monitoring attachment integrity of a wind turbine blade having a blade root attached to a pitch bearing of a wind turbine, the system comprising:
a displacement sensor mounted to measure a displacement of the blade root relative to the pitch bearing in a direction parallel to a longitudinal axis of the blade;
a computer connected to the displacement sensor and configured to record the measured displacement over time.

The computer may be configured to periodically transmit recorded displacement data to a remote computer system.

The computer may be configured to determine a displacement amplitude. The computer may be configured to trigger an alert if the displacement amplitude exceeds a predetermined displacement amplitude threshold.

The displacement sensor may be a first displacement sensor mounted to measure a first displacement at a first location around the pitch bearing, the system comprising a second displacement sensor mounted to measure a second displacement between the blade root and the pitch bearing in the direction parallel to the longitudinal axis of the blade at a second location around the pitch bearing.

The computer may be configured to record the measured first and second displacements over time and determine a phase difference between the first and second displacements.

The computer may be configured to trigger an alert if the phase difference changes by more than a predetermined phase threshold.

The computer may be configured to transmit the alert as a signal transmitted from the wind turbine to a remote computer.

The computer may be configured to transmit the alert signal to a controller of the wind turbine, the controller configured to cause the wind turbine to cease or derate operation on receiving the alert signal.

The displacement sensor may comprise a first part mounted to the blade root and a second part mounted to the pitch bearing. One of the first and second parts may comprise a non-contact inductive displacement sensor and the other of the first and second parts a target plate.

### DETAILED DESCRIPTION

The invention is described in further detail below by way of example and with reference to the accompanying drawings, in which:

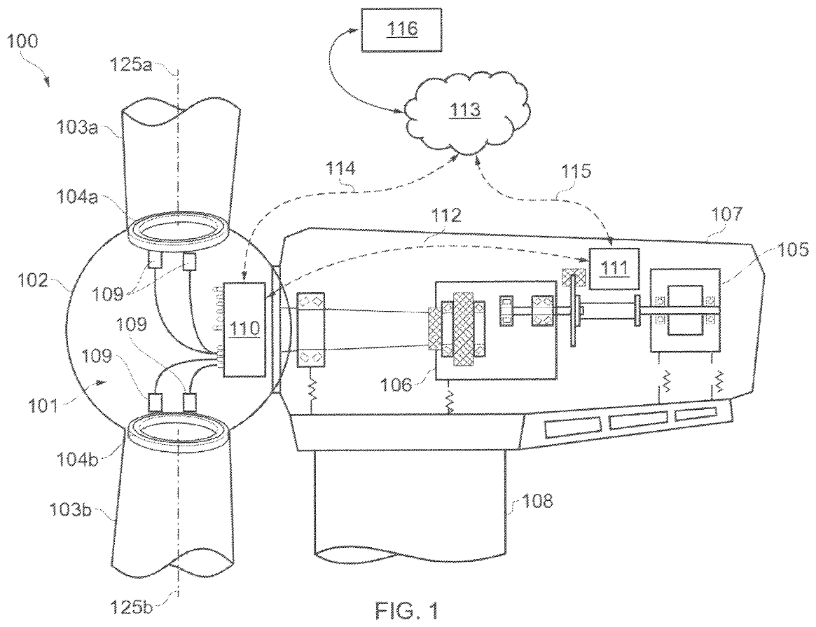

FIG. 1 is a schematic diagram of a portion of a wind turbine including a monitoring system;

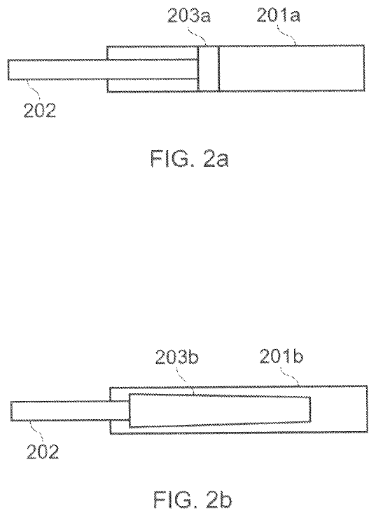

FIGS. 2a and 2b are schematic diagrams illustrating in partial perspective view two different attachment mechanisms for a wind turbine blade root;

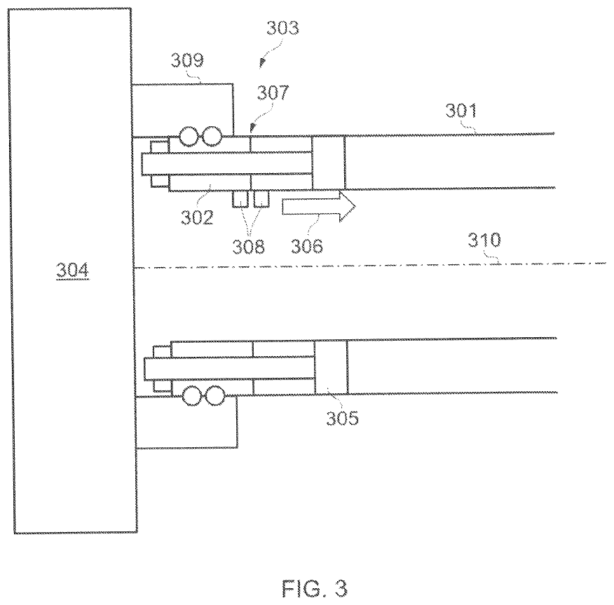

FIG. 3 is a schematic diagram of a cross-section along a longitudinal axis of a blade root attached to a pitch bearing of a wind turbine;

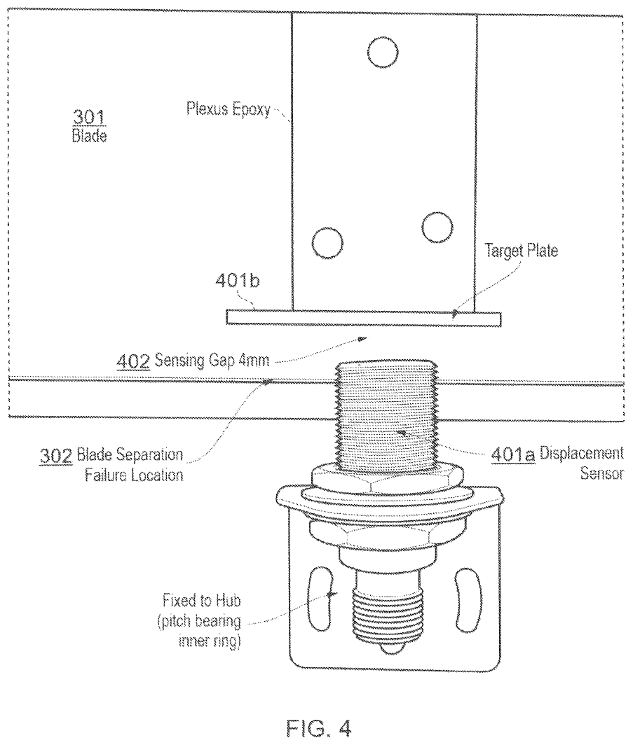

FIG. 4 is a photograph of an example displacement sensor mounted for measuring a displacement between a pitch bearing and a blade root;

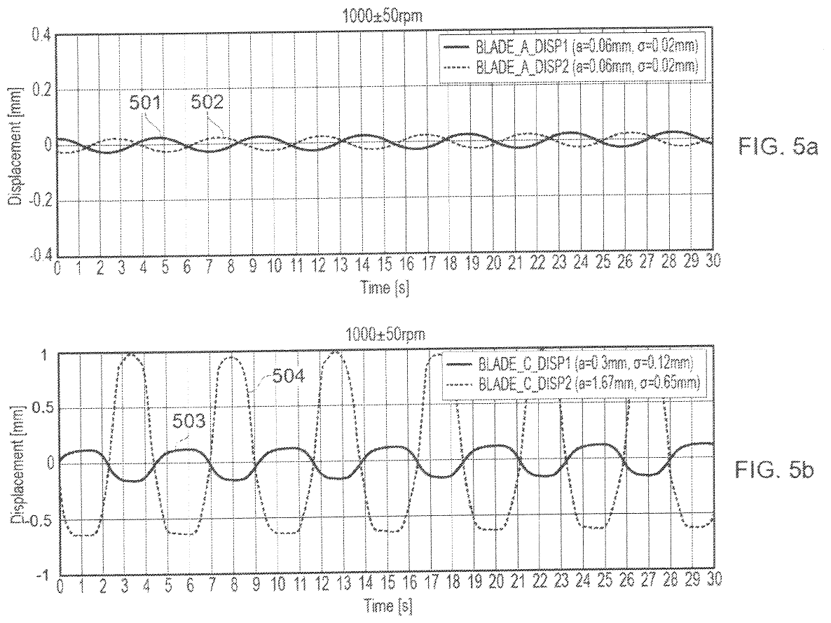

FIG. 5a is a plot of displacement over time for a pair of displacement sensors mounted to measure displacement between a first blade root and pitch bearing at different positions around the pitch bearing;

FIG. 5b is a plot of displacement over time for a pair of displacement sensors mounted to measure displacement between a second blade root and pitch bearing at different positions around the pitch bearing;

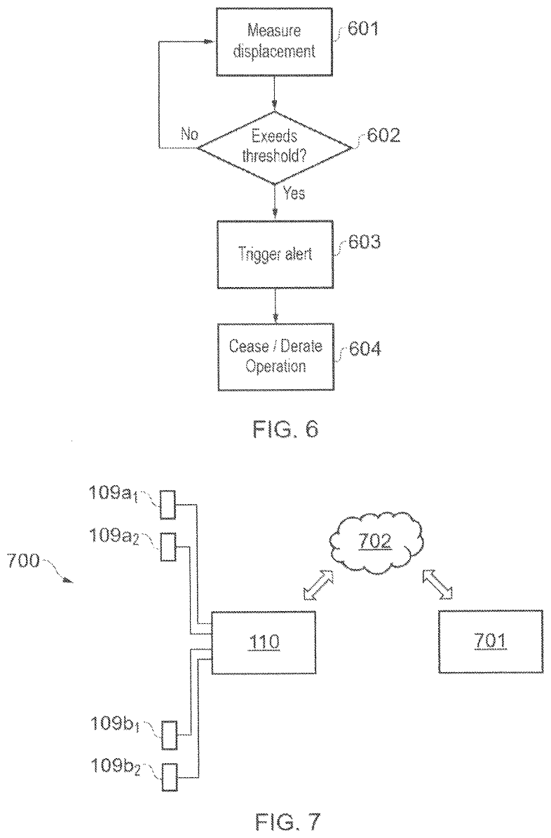

FIG. 6 is a flow diagram illustrating an example method of monitoring attachment integrity of a wind turbine blade;

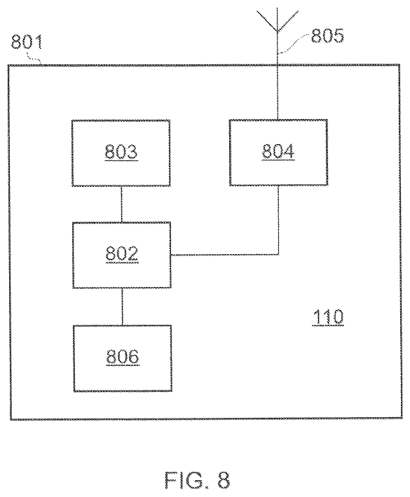

FIG. 7 is a schematic diagram of an example system for monitoring attachment integrity of a wind turbine blade; and

FIG. 8 is a schematic diagram of an example computer for the system of FIG. 7.

FIG. 1 illustrates schematically a partial view of a wind turbine 100 comprising a monitoring system 101 for monitoring components in and around the hub 102 of the turbine 100. Wind turbine blades 103a, 103b are attached to the hub 102 via pitch bearings 104a, 104b, which permit the blades 103a, 103b to be rotated about their longitudinal axes 125a, 125b. The wind turbine 100 will typically have three blades, two of which are shown in FIG. 1. The hub 102 is rotatably mounted to a generator 105 via a gearbox 106, both of which are located in a nacelle 107 mounted on top of a tower 108.

The monitoring system 101 comprises various sensors 109, which may be mounted around or on the pitch bearings 104a, 104d to enable the condition of the pitch bearings 104a, 104b to be monitored, as for example described in GB2209752.1, the disclosure of which is incorporated herein by reference. The sensors 109 may include one or more acoustic sensors, vibration sensors and displacement sensors. Further sensors may be located along the blades 104a, 104b. Damage events, or potential damage events, may be detected by measurement of vibration or displacement of the pitch bearings and/or the blades 104a, 104b. Sensor data is received by a computer 110 and recorded. The computer 110 may communicate with a controller 111 of the wind turbine via a wired or wireless connection 112. The computer 110 may communicate to a network 113 via the controller 111 and/or via one or more wireless or wired connections 114, 115. The connections 114, 115 may for example be 4G or 5G radio communications links. Data recorded by the computer 110 may be periodically transmitted to a remote computer 116 via the network 113 for analysis. Analysis of the recorded data may also be carried out locally by the computer 110.

FIGS. 2a and 2b illustrate partial sectional views of a wind turbine blade root 201a, 201b, showing alternative mechanisms for attachment of the blade root 201a, 201b to a pitch bearing. In each case, bolts 202 are screwed into inserts 203a, 203b embedded in the blade root 201a, 201b. The inserts may for example be in the form of a T-shaped insert 203a as in FIG. 2a or a tapered insert 203b as in FIG. 2b. Periodic loading of the blade root 201a, 201b during operation of the wind turbine may over time cause the inserts 203a, 203b to become loose. Further loading will tend to result in small movements of the inserts within the blade root causing abrasion and degradation of the blade root material surrounding the inserts, particularly in the case of the tapered insert 203b. In extreme cases, the inserts 203a, 203b may detach from the blade root 201a, 201b, resulting in cascading failure of adjacent inserts and ultimately detachment of the blade, which may result in catastrophic failure of the wind turbine.

FIG. 3 illustrates a schematic cross-sectional diagram of a blade root 301 attached to the inner ring 302 of a pitch bearing 303, which itself is attached to a hub 304 of a wind turbine. In this example the blade root 301 comprises inserts 305 of the T-shaped type shown in FIG. 2a, although other types of inserts may be used. Following loosening of the inserts 305 over a period of time, an unbalanced force 306 may cause the blade root 301 to detach from the pitch bearing 303 along an interface 307 between the blade root 301 and the pitch bearing 303. Before this happens, small displacements of the blade root 301 relative to the pitch bearing 303 may provide an advance indication of impending failure. One or more displacement sensors 308 mounted to measure a displacement of the blade root 301 relative to the pitch bearing 303 may therefore enable detection of such an impending failure and enable action to be taken to prevent this before it happens.

The displacement sensor 308 comprises two parts, one part mounted on the blade root 301 and another part mounted on the pitch bearing 303. In this example, the blade root 301 is mounted to the inner ring 302 of the pitch bearing 303. In alternative examples the blade root 301 may be mounted to the outer ring 309 of the pitch bearing 303. The displacement sensor 308 is mounted to measure a displacement of the blade root 301 relative to the pitch bearing 303 in a direction parallel to the longitudinal axis 310 of the blade.

A photograph of an example displacement sensor in position is shown in FIG. 4. The displacement sensor comprises a sensor part 401a and a target part 401b. The target part 401b is in the form of a metal plate extending from the inner surface of the blade root 301. The sensor part 401a is fixed to the inner surface of the inner ring 302 of the pitch bearing, while the target part 401b is fixed to the blade root 301. Similar results may be obtained by fixing the sensor part 401a to the blade root 301 and the target part 401b to the pitch bearing. Both parts 401a, 401b are fixed in position with epoxy to avoid any damage to the blade root 301 or pitch bearing 302. A sensing gap 402 between the sensor part 401a and the target part 401b allows for a small amount of relative movement between the target part 401b and sensor part 401a without the parts coming into contact. In this example the sensing gap is around 4 mm. The displacement sensor part 401a in this example is a non-contact inductive displacement sensor, which operates to detect changes in displacement of as little as 0.25 μm. The relative movement of the blade root 301 and pitch bearing 303 can thereby be measured with high accuracy, allowing detection of abnormal changes in expected displacement during operation.

Other types of displacement sensor may alternatively be used, for example based on optical or mechanical displacement sensing. The displacement sensor may be a non-contact displacement sensor, which encompasses inductive and optical sensors, or may be a contact sensor, which encompasses mechanical sensors. An advantage of using an inductive sensor is in the stability of reading regardless of the surrounding environment, while optical sensors may be subject to dirt and dust ingress and mechanical sensors may degrade over time or suffer mechanical breakage.

More than one displacement sensor may be mounted, which enables detection of displacements around the interface between the blade root and the pitch bearing. Optimal positioning of a single displacement sensor around a point of maximum loading may, however, be sufficient to detect increased displacements that precede failure. Peak loading of the blade root-pitch bearing interface will tend to be towards the front of the hub when the blade is pitched to face incident wind.

FIGS. 5a and 5b show example displacement measurements over time for respective first and second blades (blade A in FIG. 5a and blade B in FIG. 5b). In each case, two displacement sensors were positioned around 180° apart around the pitch bearing. For blade A, the displacement readings show a roughly sinusoidal trace over time, with a period that matches the rotational speed of the hub, each trace showing a peak to peak amplitude of around 0.06 mm (60 μm) with a standard deviation of around 0.02 mm (20 μm). A first displacement reading 501 is roughly 180° out of phase with the second displacement reading 502, corresponding to the position of the respective displacement sensors. For blade B, which also has displacement sensors similarly positioned around the blade root and pitch bearing, a first displacement reading 503 shows a peak to peak amplitude of around 0.3 mm with a standard deviation of around 0.12 mm, while a second displacement reading 504 shows a peak to peak amplitude of around 1.67 mm with a standard deviation of around 0.65 mm. Both displacement readings 503, 504 are substantially higher than those for blade A, which indicates a possible failure of one or more of the inserts in the blade root. The substantially higher peak displacements in the second trace 504 further indicates that failure is likely to happen around the location of the respective displacement sensor. It is also evident from the shapes of the traces 503, 504 that the displacement is no longer sinusoidal, but is becoming more clipped and, in the case of the second trace 504, asymmetrical. This further indicates loosening of inserts and periodic loading causing the inserts to move within the blade root rather than purely or mainly elastic loading that will tend to result in the more sinusoidal traces 501, 502 of blade A.

By recording and monitoring the displacement of the blade root relative to the pitch bearing as described above, an alert may be triggered if a displacement amplitude exceeds a predetermined threshold. This may for example be determined by continuously measuring an amplitude, for example a peak to peak or RMS amplitude, of the displacement trace over time. A moving average may be determined over a set time period, for example over a period of between around 10-100 seconds. If the determined displacement amplitude exceeds the predetermined threshold for any of the displacement sensors, an alert may be triggered. In the example shown in FIGS. 5a and 5b, the threshold may be set to be a peak to peak amplitude of between around 0.2 and 1 mm. The threshold amplitude may be empirically determined for a class of wind turbine or may be determined based on a background amplitude from measurements taken over a longer period of time, for example over a period of hours or days following an inspection. If the amplitude rises by a predetermined amount above this, for example rising above between around 50% and 200% of the background amplitude, the alert may be triggered.

An alert may also or alternatively be triggered if a measured phase difference between first and second displacements over time changes by more than a predetermined phase threshold. For displacement sensors positioned around 180° apart, a phase difference of around 180° would be expected. If this changes, possibly in combination with an increased displacement amplitude, this may also indicate a potential failure of the connection between the blade root and pitch bearing.

FIG. 6 illustrates a flow diagram of an example method of monitoring attachment integrity of a wind turbine blade. In a first step 601, a displacement of the blade root relative to the pitch bearing is measured. In a second step 602, which may be carried out periodically, a check is made as to whether the measured displacement exceeds a predetermined threshold, whether this is an amplitude or a phase of the displacement over time. If the threshold is exceeded, an alert is triggered at step 603. Otherwise, the process repeats.

The alert, which may be triggered by the computer mounted locally on the wind turbine or by a remote computer monitoring displacement and other measurements on the wind turbine, may prompt a user of the remote computer to request an inspection of the wind turbine. The blade in question showing the abnormal displacements may be scheduled for inspection. Optionally, the alert may be sent to a local controller of the wind turbine that may cause the controller to cease or derate operation of the turbine (step 604), for example by feathering the blades and stopping or slowing rotation of the hub to prevent further damage to the blade root connections pending an inspection and possible repair.

FIG. 7 illustrates schematically an example system 700 for monitoring attachment integrity of a wind turbine blade. The system 700 comprises one or more displacement sensors 109a₁, 109a₂, 109b₁, 109b₂ mounted to a root of each blade of the wind turbine. The computer 110 located on the wind turbine is connected to record displacement signals from each of the displacement sensors 109a₁, 109a₂, 109b₁, 109b₂ and is configured to perform signal processing, decide whether to create an alert based on thresholds and periodically transmit recorded displacement data to a remote computer system 701. Transmission of the recorded displacement data may be done via a wireless connection, for example via a mobile data connection, that connects the computer 110 to the remote server 701 via the internet 702. Signal processing may alternatively be carried out remotely by the remote server 701, with the computer 110 performing data gathering and transmission functions.

Operation of the system 700 is as described above, with processing of the recorded displacement signal data typically being carried out by the remote computer system 701. The remote computer system 701 may for example be a cloud-based computing service and may receive displacement signal data from a plurality of wind turbine monitoring systems.

Referring to FIG. 8, an example computer 110 for the system described above includes a non-transitory computer-readable medium with program instructions stored thereon for performing the above-described method. In some embodiments, the computer 110 may include at least one memory 803, at least one processor 802, a network interface 804 and a sensor interface 806 for receiving signals from one or more displacement sensors. Additionally or alternatively, in other embodiments the computer 110 may include a different type of computing device operable to carry out the program instructions. For example, in some embodiments, the computer 110 may include an application-specific integrated circuit (ASIC) that performs processor operations, or a field-programmable gate array (FPGA).

While the computer 110 of the system may be included in a single unit and/or provided in a distinct housing 801, as shown in FIG. 8, in other embodiments at least some portion of the computer 110 may be separate from the housing 801. For example, in some embodiments, one or more parts of the computer 110 may be part of a smartphone, tablet, notebook computer, or wearable device. Further, in some embodiments, the computer 110 may be a client device, i.e., a device actively operated by the user, while in other embodiments, the computer 110 may be a server device, e.g., a device that provides computational services to a client device. Moreover, other types of computational platforms are also possible in embodiments of the disclosure.

The memory 803 is a computer-usable memory, such as random-access memory (RAM), read-only memory (ROM), non-volatile memory such as flash memory, a solid-state drive, a hard-disk drive, an optical memory device, and/or a magnetic storage device. The memory 803 may be used to store recorded displacement data prior to being transmitted.

The processor 802 of the computer 110 includes computer processing elements, e.g., a central processing unit (CPU), a digital signal processor (DSP), or a network processor. In some embodiments, the processor 802 may include register memory that temporarily stores instructions being executed and corresponding data and/or cache memory that temporarily stores performed instructions. In certain embodiments, the memory 803 stores program instructions that are executable by the processor 802 for carrying out the methods and operations of the disclosure, as described herein.

The network interface 804 provides a communications medium, such as, but not limited to, a digital and/or an analog communication medium, between the computer 110 and other computing systems or devices. In some embodiments, the network interface 804 may operate via a wireless connection, such as IEEE 802.11 or BLUETOOTH, using an antenna 805 to send and receive signals, while in other embodiments the network interface 804 may operate via a physical wired connection, such as an Ethernet connection. Still in other embodiments, the network interface 804 may communicate using another convention. The network interface 804 may also or alternatively operate according to a wireless telecommunications standard, for example a 3G, 4G or 5G standard, to transmit and receive data.

An advantage of the method and system described herein is that, by focused measurement of relative displacements of a blade root relative to a pitch bearing, potential failure of the blade root connection, and consequential failure of the wind turbine, can be prevented. Cost effective repairs can then be scheduled prior to failure.

Other embodiments are intentionally within the scope of the invention, which is defined by the appended claims.

1. A method of monitoring attachment integrity of a wind turbine blade having a blade root attached to a pitch bearing of a wind turbine, the method comprising measuring during operation of the wind turbine a displacement of the blade root relative to the pitch bearing in a direction parallel to a longitudinal axis of the blade.

2. The method of claim 1, comprising recording the measured displacement over time and determining a displacement amplitude.

3. The method of claim 2, comprising triggering an alert if the displacement amplitude exceeds a predetermined displacement amplitude threshold.

4. The method of claim 1, wherein the displacement is a first displacement at a first location around the pitch bearing, the method comprising measuring a second displacement between the blade root and the pitch bearing in the direction parallel to the longitudinal axis of the blade at a second location around the pitch bearing.

5. The method of claim 4, comprising recording the measured first and second displacements over time and determining a phase difference between the first and second displacements.

6. The method of claim 5, comprising triggering an alert if the phase difference changes by more than a predetermined phase threshold.

7. The method of claim 3, wherein the alert is a signal transmitted from the wind turbine to a remote computer.

8. The method of claim 3, wherein the alert is a signal transmitted to a controller of the wind turbine, the controller causing the wind turbine to cease or derate operation on receiving the alert signal.

9. The method claim 3, wherein the displacement is measured by a displacement sensor comprising a first part mounted to the blade root and a second part mounted to the pitch bearing.

10. The method of claim 9, wherein the displacement sensor is a non-contact displacement sensor.

11. The method of claim 10, wherein the displacement sensor is an inductive displacement sensor or an optical displacement sensor.

12. The method of claim 9, wherein the displacement sensor is a mechanical sensor.

13. The method of claim 10, wherein one of the first and second parts comprises a non-contact inductive displacement sensor and the other of the first and second parts comprises a target plate.

14. A system for monitoring attachment integrity of a wind turbine blade having a blade root attached to a pitch bearing of a wind turbine, the system comprising:
a displacement sensor mounted to measure a displacement of the blade root relative to the pitch bearing in a direction parallel to a longitudinal axis of the blade;
a computer connected to the displacement sensor and configured to record the measured displacement over time.

15. The system of claim 14, wherein the computer is configured to periodically transmit recorded displacement data to a remote computer system.

16. The system of claim 14, wherein the computer is configured to determine a displacement amplitude.

17. The system of claim 16, wherein the computer is configured to trigger an alert if the displacement amplitude exceeds a predetermined displacement amplitude threshold.

18. The system of claim 14, wherein the displacement sensor is a first displacement sensor mounted to measure a first displacement at a first location around the pitch bearing, the system comprising a second displacement sensor mounted to measure a second displacement between the blade root and the pitch bearing in the direction parallel to the longitudinal axis of the blade at a second location around the pitch bearing.

19. The system of claim 18, wherein the computer is configured to record the measured first and second displacements over time and determine a phase difference between the first and second displacements.

20. The system of claim 19, wherein the computer is configured to trigger an alert if the phase difference changes by more than a predetermined phase threshold.

21. The system of claim 17, wherein the computer is configured to transmit the alert as a signal transmitted from the wind turbine to a remote computer.

22. The system of claim 17, wherein the computer is configured to transmit the alert signal to a controller of the wind turbine, the controller configured to cause the wind turbine to cease or derate operation on receiving the alert signal.

23. The system of claim 14, wherein the displacement sensor comprises a first part mounted to the blade root and a second part mounted to the pitch bearing.

24. The system of claim 23, wherein one of the first and second parts comprises a non-contact inductive displacement sensor and the other of the first and second parts comprises a target plate.
